(19) United States
(12) Patent Application Publication
(10) Pub. No.: US 2025/0156153 A1
(43) Pub. Date: May 15, 2025

(54) AUTOMATED ENHANCEMENTS AND ANALYTICS FOR COMPUTER PROGRAM DEVELOPMENT

(71) Applicant: ServiceNow, Inc., Santa Clara, CA (US)

(72) Inventors: Maria S. Goldberg, Redmond, WA (US); Rakesh R. Mula, Hyderabad (IN)

(21) Appl. No.: 18/388,476

(22) Filed: Nov. 9, 2023

(51) Int. Cl. G06F 8/10; G06F 40/40; G06Q 10/0631

(52) U.S. Cl. CPC G06F 8/10; G06F 40/40; G06Q 10/063118; G06Q 10/06313

(57) ABSTRACT

A transcript of at least a portion of a discussion associated with a computer program development is received. At least a portion of the transcript is automatically analyzed to automatically identify a computer program development project associated with the discussion and managed by a computer program development project management software. At least a portion of the transcript and contextual information of the computer program development project tracked using the computer program development project management software is provided to a large language model to automatically generate a specification of a task of the computer program development discussed during the discussion. Based on the generated specification of the task, the task is automatically tracked using the computer program development project management software.

### BACKGROUND OF THE INVENTION

Computer program development can be managed and organized using computer program development project software. The development project software, which can be offered as a software cloud service, helps project managers and developers coordinate the software program development process by organizing a computer program using a project development framework. The framework provides structure to a large project and allows the project to be managed as multiple tasks with assigned resources and requirements. The framework can also be used to organize the development project around team members and their assigned tasks.

### BRIEF DESCRIPTION OF THE DRAWINGS

Various embodiments of the invention are disclosed in the following detailed description and the accompanying drawings.

FIG. 1 is a block diagram illustrating an example of a network environment for automatically enhancing and providing analytics for computer program development.

FIG. 2 is a block diagram illustrating an embodiment of a project enhancements and analytics module for automatically providing enhancements and analytics for a project management service.

FIG. 3 is a flow chart illustrating an embodiment of a process for automatically providing enhancements and analytics for a project management service.

FIG. 4 is a flow chart illustrating an embodiment of a process for automatically providing project enhancements for a project management service.

FIG. 5 is a flow chart illustrating an embodiment of a process for automatically providing project task enhancements for a project management service using a generative artificial intelligence (AI) prompt and a trained large language model.

FIG. 6 is a flow chart illustrating an embodiment of a process for automatically providing project resource predictions for a project management service using a trained analytics model.

FIG. 7 is a functional diagram illustrating a programmed computer system for automatically enhancing and providing analytics for computer program development.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automated enhancements and analytics for computer program development and the management of computer program development are disclosed. For example, using the disclosed techniques and systems, a computer program project under management by a computer program development project management service can be enhanced with automatically generated features such as automatically generated tasks and resource estimations. In some embodiments, the generated tasks of a computer program project correspond to new features to be added and scheduled for development as well as fixes or identified defects associated with an existing feature that require addressing, among other features. Using the disclosed techniques, the new tasks can be automatically generated based on analyzing a transcript that describes the desired functionality, such as a transcript of a team meeting describing project goals and functionality. Using the transcript, which itself can be automatically generated, such as from a video conference recording, and any existing relevant project context retrieved from the computer program development project management service, a large language model can be used to automatically determine and generate the desired scheduled tasks. For example, the large language model can be provided with a generative artificial intelligence (AI) prompt that embeds the retrieved project context and relevant transcript details. In response to a provided generative AI prompt, a scheduled project task is automatically generated for and tracked by the computer program development project management service. In some embodiments, the different tasks are differentiated by keywords such as trigger words (or phrases) identified in the transcript and/or related project context. For example, the trigger words “enhancement,” “suggestion,” “idea,” “improvement,” “request,” and/or “feature request” can be designated to generate and track a new task for the project to implement the associated feature. As another example, the trigger words “problem,” “malfunction,” “doesn't work,” and/or “missing” can be designated to signify that a task to resolve a defect associated with a project feature should be generated and tracked. Fewer or additional trigger words can be supported and/or automatically added.

In some embodiments, the tracked tasks are associated with resource allocations, such as the number of hours, developers, developer skills, and/or hardware/software requirements, among other resources. Using the tracked resource allocations, a machine leaning model is trained to predict resource requirements for new projects including new project features. For example, the resource requirements for a new project feature including one described by an automatically generated task can be predicted by applying the trained machine learning model. In some embodiments, the estimated resources can include the number of hours, the number of developers required, hardware and/or software resources, etc. In some embodiments, the estimated resources can be constrained based on availability, such as the number of available developers including identifying developers with different levels of experience and ability. Similarly, the estimated resources can be constrained based on availability of resources such as software and/or hardware resources. In various embodiments, based on the provided history of resource usage and available resources, the trained model can estimate the resource requirements associated with a task and/or project. In some embodiments, the estimated resource is an aggregate value such as an agreed upon metric or unit of measure. In some embodiments, the estimated resource metric is a unit of measure for expressing an estimate of the overall effort required and approximates the number of hours, team members, and/or other resources required.

In some embodiments, a transcript of at least a portion of a discussion associated with a computer program development is received. For example, a video conference between a development team discussing a computer program development project is recorded and a transcript of the video conference is generated. In various embodiments, the received transcript can be generated manually and/or automatically, such as by applying natural language processing (NPL) techniques to convert at least the audio portion of the video recording to a transcript. In some embodiments, the transcript includes transcribed descriptions of video elements of the recorded video conference, such as gestures or actions performed by the video conference participants including actions performed on a computer user interface such as while demonstrating a feature of the computer program. Other visual actions include user interface interactions such as zooming in on a user interface, clicking on a button, opening a dialog box, typing a description or name of an item, clicking, scrolling, hovering, closing a user interface element, and reloading a user interface element, among others. In various embodiments, the transcript can be generated in real-time, such as during a video conference, and/or the transcript can be based on an audio recording.

In some embodiments, at least a portion of the transcript is automatically analyzed to automatically identify a computer program development project associated with the discussion and managed by a computer program development project management software. For example, the transcript is analyzed to identify a specific computer program under development. The program's development is managed using the computer program development project management software. For example, features, requirements, goals, team members, and/or communications, etc. can all be captured and managed using the computer program development project management software. The appropriate project can be identified by analyzing the received transcript such as by identifying the computer program development project by project features such as the project name, project team members, project time frame, project feature set, project product deadline, etc.

In some embodiments, at least the portion of the transcript and contextual information of the computer program development project tracked using the computer program development project management software is provided to a large language model to automatically generate a specification of a task of the computer program development discussed during the discussion. For example, once the project is identified within the computer program development project management software, specifications including documentation and metadata of the project can be retrieved and provided as contextual information for the project. Along with the retrieved contextual information, at least a portion of the transcript is provided to a large language model to automatically generate a task specification for the project. The generated task specification corresponds to the discussion included in the transcript. Rather than requiring a team member to manually enter the task specification into the computer program development project management software based on the results of the discussion, the task specification is automatically generated by the large language model based on the provided input data.

In some embodiments, based on the generated specification of the task, the task is automatically tracked using the computer program development project management software. For example, the automatically generated task specification is entered into the computer program development project management software for tracking the task, such as the progress of the task. In some embodiments, the tracking includes completion properties such as how long the task takes to complete, the number and skills required to complete the task, and/or other metrics and/or analytics of the task. In various embodiments, based on the tracked data gathered from tracking the task, predictions can be made on future tasks such as the estimated amount of resources such as time, developers, and/or hardware required to perform one or more steps of the task.

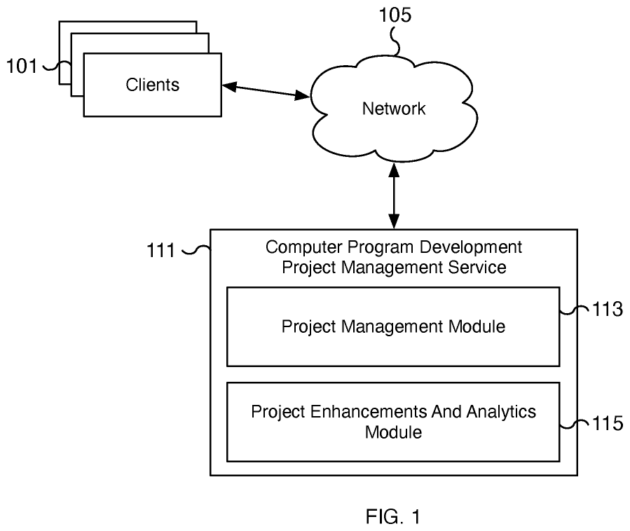

FIG. 1 is a block diagram illustrating an example of a network environment for automatically enhancing and providing analytics for computer program development. In the example shown, clients 101 and computer program development project management service 111 are communicatively connected via network 105. Network 105 can be a public or private network. In some embodiments, network 105 is a public network such as the Internet. In various embodiments, computer program development project management service 111 is a cloud-based service for managing the development of computer programs. For example, using computer program development project management service 111, users such as users corresponding to clients 101 can manage a software project including the planning of the project using a project development framework. The disclosed enhancing and providing analytics provided for computer program development project management service 111 include the ability to automatically generate tasks for projects, track analytics related to projects, and predict resource requirements for projects. In various embodiments, the participants in a project can access computer program development project management service 111 via clients 101.

In some embodiments, clients 101 correspond to the client participants of a software program project and may include clients such as project managers, program designers, development engineers, quality assurance engineers, deployment engineers, etc. Clients 101 can include one or more clients and can correspond to one or more network devices such as a desktop computer, a laptop, a mobile device, a tablet, a kiosk, a voice assistant, a wearable device, or another network computing device. In some embodiments, clients 101 can correspond to applications utilized by the team members including team-based applications such as video conferencing applications, shared note taking applications, etc. For example, clients 101 can correspond to a video conferencing application that provides a transcript of a conference where project details are discussed between one or more team members.

In some embodiments, computer program development project management service 111 is a service accessible to clients 101 for managing the development of computer software programs. Example programs can include web applications, service applications, standalone desktop applications, etc. In some embodiments, computer program development project management service 111 is used for project development outside of the context of computer programs. As shown in FIG. 1, computer program development project management service 111 includes project management module 113 and project enhancements and analytics module 115. Project management module 113 includes functionality for managing a project and supports tasks such as creating a feature based on a specification and fixing defects identified in a feature. Project management module 113 may conform to a specific project management framework (or process) such as one based on agile development principles. In various embodiments, project management module 113 can provide visibility into the managed projects such as their process, dependencies, resource allocation, resource usage, resource estimates, task tracking, task analytics, etc. Project management module 113 is enhanced by project enhancements and analytics module 115 and at least in part by its machine learning and generative artificial intelligence (AI) functionality. For example, project enhancements and analytics module 115 can automatically create scheduled tasks that are managed by project management module 113 and determine project analytics and resource predictions that are displayed by project management module 113.

In some embodiments, project enhancements and analytics module 115 is a module for implementing the automatic generation of tasks related to projects of a computer program development management service such as computer program development project management service 111. For example, project enhancements and analytics module 115 can automatically create tasks for an automatically identified project based on a provided transcript discussing the project. Using a transcript of a team meeting discussing features and/or fixes related to a project, project enhancements and analytics module 115 can automatically create the associated project tasks as entries within computer program development project management service 111. Example tasks can include a task to implement a new feature including the requirements of the feature as well as a task to fix a defect identified in an existing feature. In various embodiments, project enhancements and analytics module 115 further provides analytics functionality including resource prediction for projects managed by computer program development project management service 111. For example, computer program development project management service 111 includes a trained machine learning model to predict resource requirements or estimated resource usage for projects. The predicted estimates can be predicted in a unit of value such as number of hours, number of developers, required hardware and/or software, and/or another estimated unit such as an estimated unit of work. For example, certain computer program development management services may utilize a unit of work that is an approximation and/or aggregation of multiple metrics and project enhancements and analytics module 115 can predict a resource estimation using a computer program development management service's preferred unit of measure.

Although project enhancements and analytics module 115 is shown in FIG. 1 as a component of computer program development project management service 111, in some embodiments, project enhancements and analytics module 115 is a standalone service and can interface with computer program development project management service 111 as an independent service. For example, computer program development project management service 111 and project enhancements and analytics module 115 can be implemented as separate services that can interface via web application programming interfaces or another appropriate interface. Although not shown in FIG. 1, project enhancements and analytics module 115 can be configured to interface with multiple different computer program development management services (not shown) in order to provide enhanced features including automatically generated tasks and estimated resource prediction.

Although single instances of some components have been shown to simplify the diagram, additional instances of any of the components shown in FIG. 1 may exist. For example, additional clients including client applications other than clients 101 may exist and be located in a different location such as a different network location. Similarly, additional instances of computer program development project management services may exist other than computer program development project management service 111. In some embodiments, computer program development project management service 111 may be just one cloud service offered by a cloud service provider. For example, other cloud services such as a configuration management database (CMDB) service may be offered along with the computer program development project management service 111. In various embodiments, computer program development project management service 111 comprises additional components not shown, such as one or more storage components that can include data stores and/or databases for storing project related data.

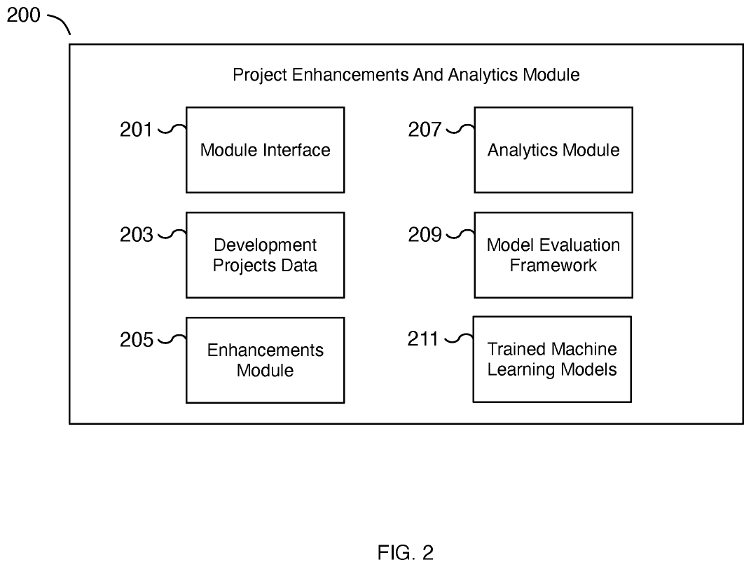

FIG. 2 is a block diagram illustrating an embodiment of a project enhancements and analytics module for automatically providing enhancements and analytics for a project management service. In the example shown, project enhancements and analytics module 200 includes module interface 201, development projects data 203, enhancements module 205, analytics module 207, model evaluation framework 209, and trained machine learning models 211. In various embodiments, project enhancements and analytics module 200 utilizes machine learning and generative artificial intelligence (AI) to provide enhancements to a computer program development project management service. For example, project enhancements and analytics module 200 can interface with a development project management service to automatically create and schedule project tasks and/or to automatically predict resource requirements for projects being managed by the service. In some embodiments, the computer program development project management service is computer program development project management service 111 of FIG. 1 and project enhancements and analytics module 200 is project enhancements and analytics module 115 of FIG. 1. In some embodiments, project enhancements and analytics module 200 interfaces with a module of the computer program development project management service such as project management module 113 of FIG. 1.

In some embodiments, module interface 201 is an interface module for communicating with a computer program development project management service. For example, using module interface 201, tasks for a project can be created, added, and/or performed for the computer program development project management service. In some embodiments, module interface 201 includes a set of application programming interfaces (APIs) that expose functionality of project enhancements and analytics module 200. In some embodiments, module interface 201 invokes APIs of the computer program development project management service, such as to provide automatically generated enhancements, analytics, and/or resource predictions. In various embodiments, module interface 201 can be configured to interface with an external interface of the computer program development project management service and/or an internal interface of the computer program development project management service such as a program management module. For example, module interface 201 can be configured to interface with the management service differently depending on whether project enhancements and analytics module 200 is an independent service or an internal component of the computer program development project management service.

In some embodiments, development projects data 203 is a data store of project data for projects being managed by the associated computer program development project management service. The data store can correspond to a database and may include a configuration management database (CMDB). In some embodiments, development projects data 203 is remote from project enhancements and analytics module 200 and may be shared by and/or hosted by another component of the computer program development project management service. The data stored by development projects data 203 for each project can include specifications describing a project including specifications for project features, required and/or assigned project resources, project estimations and planning documents, etc. In some embodiments, development projects data 203 is a cache of project data that is stored elsewhere but is provided to project enhancements and analytics module 200 for performing the enhancements and analytics functionality.

In some embodiments, enhancements module 205 is a functional module for performing project development management enhancements associated with projects managed by the associated computer program development project management service. In various embodiments, enhancements can include automatically generating project tasks including specifications for new features and defects. Enhancements module 205 can utilize project data including contextual data of the project to generate new tasks. For example, enhancements module 205 can access project data via development projects data 203 and/or via the associated computer program development project management service. In various embodiments, enhancements module 205 utilizes model evaluation framework 209 and trained machine learning models 211 to automatically generate new project tasks using generative artificial intelligence (AI) prompts and a trained large language model. For example, a trained large language model of trained machine learning models 211 can be provided with a transcript of a feature and project contextual data along with a generative AI prompt to automatically generate a task specification for the associated feature. The generated task specification is then added to the project by providing the specification to the associated computer program development project management service via module interface 201.

In some embodiments, analytics module 207 is a functional module for performing and tracking analytics associated with projects managed by the associated computer program development project management service. In various embodiments, the tracked analytics include resource analytics including resource usage, utilization, and requirements. Analytics module 207 can be used to predict resource requirements such as to estimate the amount of effort required to complete a project including each of the tasks of the project. Analytics module 207 can utilize model evaluation framework 209 and trained machine learning models 211 to perform the prediction. In some embodiments, analytics module 207 is further used to train one or more models of trained machine learning models 211. For example, using tracked resource analytics of existing projects, analytics module 207 can train a deep learning model to predict resource usage for projects including prediction on the amount of work (or effort) required to complete a project and/or tasks of the project. In various embodiments, tracked analytics can be stored and/or retrieved by analytics module 207 via developments project data 203 and analytics results including resource prediction can be provided to the associated computer program development project management service via module interface 201.

In some embodiments, model evaluation framework 209 is a framework for utilizing and applying the trained models of trained machine learning models 211 to perform project specific actions. For example, model evaluation framework 209 can be used to evaluate a large language model of trained machine learning models 211 using generative artificial intelligence (AI) prompts to generate project tasks. Similarly, model evaluation framework 209 can be used to apply a deep learning analytics model to perform resource prediction such as predicting the amount of effort or work a task requires. In various embodiments, model evaluation framework 209 provides a framework for both enhancements module 205 and analytics module 207 to utilize the trained models of trained machine learning models 211 to perform project enhancement and analytics functionality.

In some embodiments, trained machine learning models 211 is a library of trained machine learning models. The trained models can include pre-trained large language models for project task generation as well as trained analytics prediction models. The one or more pre-trained large language models can be trained using significantly large amounts of data. Further, they can be enabled to process language, including human or natural language, and to provide a result in response to provided prompts. The output of a pre-trained large language model can conform to project specifications required and used by a computer program development project management service. The trained models can also include one or more analytics models for predicting resource metrics such as the amount of effort required to complete a project or a project task. In some embodiments, one or more of the trained models can be a third-party model such as a third-party large language model trained by a third-party for performing both specific and generic artificial intelligent (AI) tasks. Additional training and/or fine-tuning, such as on project specific tasks, can be performed and used to augment the models including the third-party models. In some embodiments, the training performed on the models includes training the model on development projects data including project specifications and project analytics data.

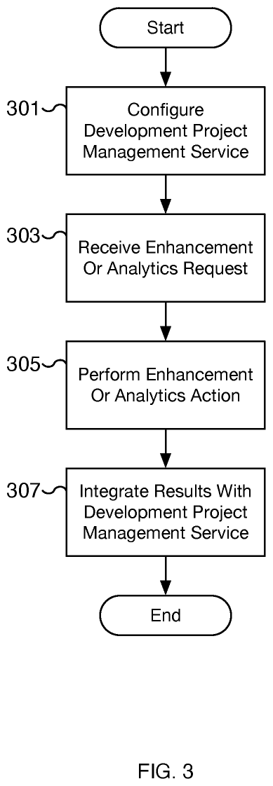

FIG. 3 is a flow chart illustrating an embodiment of a process for automatically providing enhancements and analytics for a project management service. For example, using the process of FIG. 3, a computer program development project management service can be automatically enhanced and analytics such as resource predictions can be automatically provided. Example enhancements include the automatic generation of project tasks including project features and defects that are based on verbal and/or written cues used when discussing a project. In some embodiments, the automatically providing enhancements and analytics are performed by a project enhancements and analytics module such as project enhancements and analytics module 115 of FIG. 1 and/or project enhancements and analytics module 200 of FIG. 2. In some embodiments, the computer program development project management service is computer program development project management service 111 of FIG. 1.

At 301, a computer program development project management service is configured. For example, a project management service is configured for developing computer programs. As part of the configuration, the service can be configured to expose an interface for accepting enhancements and analytics data. For example, using an exposed interface, either to internal and/or external modules, new scheduled tasks such as new features or defects can be added to existing projects. In some embodiments, the interface allows a client to retrieve project data such as project names and/or project data such as features and resource requirements. In some embodiments, the configuration includes performing one or more training processes to train machine learning models for use in providing enhancements and analytics. For example, a large language model can be trained to accept natural language and output project specifications or other enhancements. As another example, an analytics model can be trained to predict resource metrics such as resource estimates and/or utilization including estimated amounts of work estimates.

At 303, an enhancement or analytics request is received. For example, an enhancement request can be received that includes a reference to a project meeting discussion such as a discussion among project team members. In some embodiments, the meeting reference corresponds to a meeting recording or another form of project documentation such as a written meeting specification, a meeting transcript, or meeting minutes, etc. The referenced meeting data is analyzed to create new scheduled tasks such as new tasks corresponding to project features, project defects in existing features, project modifications to features, changes to project resources, etc. that were discussed during the provided meeting. The request can be received via a user interface such as a project management dashboard. In some embodiments, the request is received directly from a client application such as from a video conference application that automatically provides a recording (or live feed) of a project meeting for analysis. In some embodiments, the request is an analytics request. For example, certain enhancements are analytics enhancements such as a requested resource prediction. The requested resource prediction can be a prediction of work required to complete a project and/or project task.

At 305, an enhancement or analytics action is performed. For example, based on the provided request, the appropriate enhancement or analytics action is performed. In some embodiments, the action is automatically performed by applying trained machine learning models using a model evaluation framework. For example, project enhancements related to creating new tasks can be automatically generated by applying a generative artificial intelligence (AI) prompt to a trained large language model. The provided prompt can include project specifications such that the output of the trained large language model is a project specification that can be added to the project via an interface associated with the project management service. In some embodiments, the request relates to predictions including predications based on analytics such as resource usage. For example, one or more resource estimates can be predicted to determine a work estimate required for a project task based on a model trained on analytics data, such as analytics and other data gathered for past projects. In some embodiments, the models used at 305 are trained at 301.

At 307, the results are integrated with the development project management service. For example, the results generated from an action performed at 305 are integrated with the project managed by the development project management service. In various embodiments, the results are provided to the development project management service via an interface such as an application programming interface (API). In some embodiments, the results are integrated by updating records of a shared database such as a configuration management database (CMDB) used by the development project management service for managing the associated project. In this manner, a newly created specification, such as for a new feature or a new defect, can be added to an existing project. Similarly, resource estimates and related analytics can be added to an existing project or project task. In some embodiments, the action performed at 305 relates to a new project and a new project can be created and the associated tasks and/or analytics are added to the newly created project.

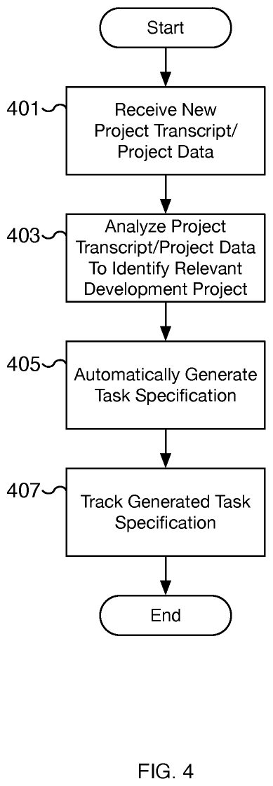

FIG. 4 is a flow chart illustrating an embodiment of a process for automatically providing project enhancements for a project management service. For example, using the process of FIG. 4, a computer program development project management service can be automatically enhanced by applying generative artificial intelligence (AI) and large language models to automatically generate project enhancements such as scheduled project tasks. In some embodiments, the process of FIG. 4 is performed at 305 and/or 307 of FIG. 3 by a project enhancements and analytics module such as project enhancements and analytics module 115 of FIG. 1 and/or project enhancements and analytics module 200 of FIG. 2. In some embodiments, the computer program development project management service is computer program development project management service 111 of FIG. 1.

At 401, a new project transcript and/or project data is received. For example, project data describing a project is received. The received project data can include a transcript of a project meeting, such as a transcript of a team meeting describing and/or discussing project features, the project status, the project goals, etc. In some embodiments, the project data is received as a video and/or audio recording of the project and the project data can be converted to a text-based transcript. In some embodiments, the project data includes meeting notes, meeting minutes, a project specification, and/or another form of project documentation that describes new enhancements that should be tracked with respect to the development project management service. In various embodiments, the project data includes visual actions performed such as gestures or actions performed by video conference participants including actions performed on a computer user interface such as while demonstrating a feature of the computer program. Other visual actions include user interface interactions such as zooming in on a user interface, clicking on a button, opening a dialog box, typing a description or name of an item, clicking, scrolling, hovering, closing a user interface element, and reloading a user interface element, among others.

At 403, the received project transcript and/or project data is analyzed to identify a relevant development project. For example, the project data received at 401 is analyzed to identify an existing project under the management of the computer program development project management service. In some embodiments, the project data can include metadata such as tags, file names, titles, team member names, etc. that are used to identify the project. In some embodiments, the project data is analyzed to identify the appropriate project by the context of the project data. For example, a trained model can be provided with the project data with a request to determine the appropriate project. In some embodiments, the model and model evaluation framework are provided with a set of existing projects and/or access to the computer program development project management service to query existing projects. In the event no existing project is identified, a new project can be identified, created, and associated with the requested enhancement.

At 405, a project task specification is automatically generated. For example, a project task specification is automatically generated using a portion of the project transcript and/or project data received at 401 and potentially additional project context data retrieved from the computer program development project management service. For example, the project data received at 401 can be analyzed to extract relevant portions such as the portions that pertain to a specific feature or defect. In some embodiments, the selected portion of the project data can be determined by analyzing the data for trigger words or phrases. For example, certain trigger words or phrases can indicate the start of a new feature, defect, or another enhancement. In some embodiments, the different tasks are differentiated by different trigger words (or phrases) identified in the transcript and/or related project context. For example, the trigger words “enhancement,” “suggestion,” “idea,” “improvement,” “request,” and/or “feature request” can be designated to generate and track a new task for the project to implement the associated feature. Other similar trigger words or phrases for a new feature may include: “enhancement suggestion,” “innovation,” “fine-tuning,” and optimization.” As another example, the trigger words “defect,” “problem,” “malfunction,” “doesn't work,” and/or “missing” can be designated to signify that a task to resolve a defect associated with a project feature should be generated and tracked. Other similar trigger words or phrases for a new defect task may include: “issue,” “inconsistency,” “blemish,” “imperfection,” “not as designed,” “not working as expected,” “working not as expected,” “unexpected behavior,” and/or “bug.” The trigger words may be combined or used in a sentence such as “We can address it as an enhancement,” and “This is a great idea, we will consider it for future releases” for enhancements and “This feature doesn't work as expected” or “I think there is a bug because . . . ” for defects. Fewer or additional trigger words can be supported and/or automatically added. In various embodiments, the trigger words and phrases are used to select the relevant portions of the project data for a task and to remove non-relevant portions.

In various embodiments, at least the relevant portions of the received project transcript or project data are extracted and used to generate a generative artificial intelligence (AI) prompt. The generative AI prompt can further include project context data retrieved from the project via the computer program development project management service. For example, once an existing (or new) project is identified at 403, project context data is retrieved for the project from the computer program development project management service and used to generate the generative AI prompt. Additional context can be further included in the generative AI prompt such as the specification used by the computer program development project management service. By providing the specification and/or examples of the specification, the generative AI prompt can request that the trained large language model generate a new task that conforms to the appropriate specification such that the new task will be accepted by the computer program development project management service.

At 407, the generated task specification is tracked. For example, the generated task is added to the project identified at 403 via an interface of the computer program development project management service. Once added to the computer program development project management service, the managed task can be tracked. The tracking performed can include tracking the progress of the task and/or scheduling requirements of the task via the computer program development project management service. In some embodiments, the tracking includes notifying the appropriate people and/or systems of the newly scheduled task. For example, team members participating in the project transcript/data received at 401 can be notified of the newly scheduled task added to their project. Upon receipt of the notification, the recipients can verify the accuracy of the automatically generated task. In some embodiments, the tracking includes tracking resources utilizes by the task as progress is made in the completion of the task.

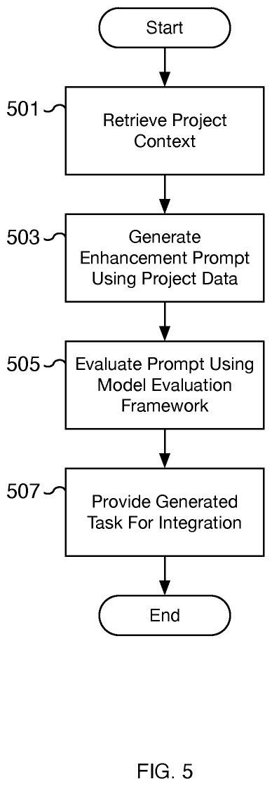

FIG. 5 is a flow chart illustrating an embodiment of a process for automatically providing project task enhancements for a project management service using a generative artificial intelligence (AI) prompt and a trained large language model. For example, using the process of FIG. 5, an enhancements module of a project enhancements and analytics module can automatically create project tasks for an identified development project managed via a computer program development project management service. The identified project can be a new project or an existing project. The new project task is created by generating a generative AI prompt using at least provided project data, such as relevant portions of a project transcript or other provided project data describing the new task. The generated prompt is then applied to a trained large language model to generated the task specification. In some embodiments, the process of FIG. 5 is performed at 305 and/or 307 of FIG. 3 and/or at 405 of FIG. 4 by an enhancements module of a project enhancements and analytics module such as enhancements module 205 of FIG. 2 of project enhancements and analytics module 115 of FIG. 1 and/or project enhancements and analytics module 200 of FIG. 2. In some embodiments, the process of FIG. 5 is performed using a model evaluation framework of the project enhancements and analytics module such as model evaluation framework 209 of FIG. 2. In some embodiments, the computer program development project management service is computer program development project management service 111 of FIG. 1.

At 501, the project context is retrieved. For example, using a development project identifier, project context data of the project is retrieved from the computer program development project management service. The retrieved context data can include project information such as existing features, defects, and/or other tasks as well as assigned resources such as the number and type of developers. Other information can include the members assigned to the project, the progress of the project, the existing project goals and deadlines, and other dependencies of the project. In various embodiments, the retrieved data can further include example tasks as well as task specifications and requirements.

At 503, a project enhancement prompt is generated using project data. For example, the project data can include the provided project transcript/project data and the project context data retrieved at 501. In various embodiments, the provided project transcript/project data can include a discussion of the new task in a natural language format. For example, the provided portions of the project transcript can include a discussion by different team members describing a new feature or a found defect that should be added as a new task to the project. In various embodiments, the generated prompt is a generative artificial intelligence (AI) prompt for a trained large language model. Included in the prompt and/or the system prompt is the requirement specification for the new task. For example, the new task can require the creation of a new task (such as a new story, feature, defect, or another enhancement task), a title, a description, acceptance criteria, and an assignment group.

At 505, the generated prompt is evaluated using a model evaluation framework. For example, the prompt generated at 503 is provided to a model evaluation framework to instruct the configured trained large language model to generate the requested specification for the new project task. The automatically generated artificial intelligence (AI) prompt provides the appropriate context for the trained large language model to create the new task according to the desired specification. Requests included in the project such as generating a title, description, acceptance criteria, and assignment group can be fulfilled by the trained large language model when provided with the appropriate project context and desired specification guidelines. In some embodiments, the evaluation framework provides the prompts as a sequence of prompts such as an initial system prompt followed by one or more additional prompts to refine the generated output.

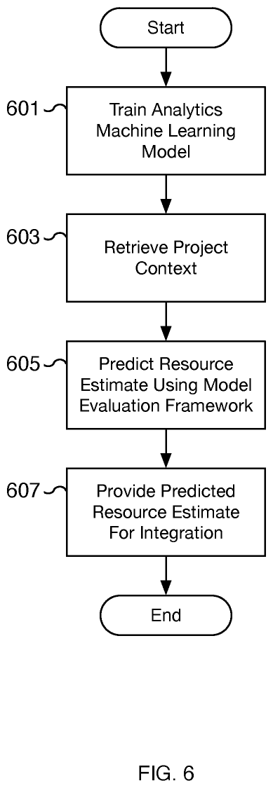

At 507, the generated task is provided for integration. For example, the generated task specification is provided to the project management service via an interface such as an application programming interface (API). In some embodiments, the generated task can be added to the new project via accessible APIs adhering to and/or that accept the project specification. In some embodiments, as part of generating a new task, a resource estimate is provided. For example, an analytics action to predict the amount of work required or to be budgeted for the new task is determined. In some embodiments, the analytics action can be via the process of FIG. 6.

FIG. 6 is a flow chart illustrating an embodiment of a process for automatically providing project resource predictions for a project management service using a trained analytics model. For example, using the process of FIG. 6, an analytics module of a project enhancements and analytics module can automatically predict resource estimates for a development project managed via a computer program development project management service. The identified project can be a new project or an existing project and the predictions can be for the project, one or more tasks of the project, and/or another related component of the project. The resource predictions are made by applying an inference step using a trained analytics machine learning model. In some embodiments, the process of FIG. 6 is performed at 301, 305 and/or 307 of FIG. 3 by an analytics module of a project enhancements and analytics module such as analytics module 207 of FIG. 2 of project enhancements and analytics module 115 of FIG. 1 and/or project enhancements and analytics module 200 of FIG. 2. In some embodiments, the process of FIG. 6 is performed using a model evaluation framework of the project enhancements and analytics module such as model evaluation framework 209 of FIG. 2. In some embodiments, the computer program development project management service is computer program development project management service 111 of FIG. 1.

At 601, an analytics machine learning model is trained. For example, a machine learning model is trained using analytics data including resource analytics data. The training data can include resource metrics data from projects as well as data related to project resources and resource constraints such as the number of developers required and the skills and skill levels of the developers. In various embodiments, the training data can be project data from the same customer such as past and current project data limited to only the same customer. In some embodiments, the training data is project data aggregated across multiple customers and can be aggregated based on customers with similar requirements. In various embodiments, the training data can be anonymized as part of preparing the data for use in training.

At 603, the project context is retrieved. For example, using a development project identifier, project context data of the project is retrieved from the computer program development project management service. The retrieved context data can include project information such as tasks, resource requirements, resource expectations, resource allocations, resource constraints, project dependencies, project time constraints, project deadlines, etc. For example, retrieved resource allocations can include information that a certain number of developers of a certain skill set have been reserved for the project. As another example, retrieved resource constraints can include a requirement that a senior user interface developer is required to perform a sub-task of a project feature. Other retrieved information can include the members assigned to the project and their availability, the progress of the project including the current status of delays, the existing project goals and deadlines, and other dependencies of the project.

At 605, a resource estimate is predicted using a model evaluation framework. For example, the project context retrieved at 603 is processed and prepared as input features to the analytics model trained at 601 to predict a resource estimate. In various embodiments, a model evaluation framework is used to load the trained model, prepare the input features, and initiate the inference step to predict the resource estimate. In some embodiments, the model evaluation framework can further process prediction results, such as performing post-processing on a prediction result to transform the result into a resource estimate format that conforms to the format used by the project management service. In some embodiments, the prediction resource estimate is provided in a unit of measure that expresses an estimate of the overall effort required.

At 607, the predicted resource estimate is provided for integration. For example, the predicted resource estimate is provided to the project management service via an interface such as an application programming interface (API). In some embodiments, the predicted resource estimate can be added to the new project via accessible APIs of the project management service. Once the resource estimate is integrated with the project management service, users can access the estimates via a user interface of the project management service such as a project dashboard.

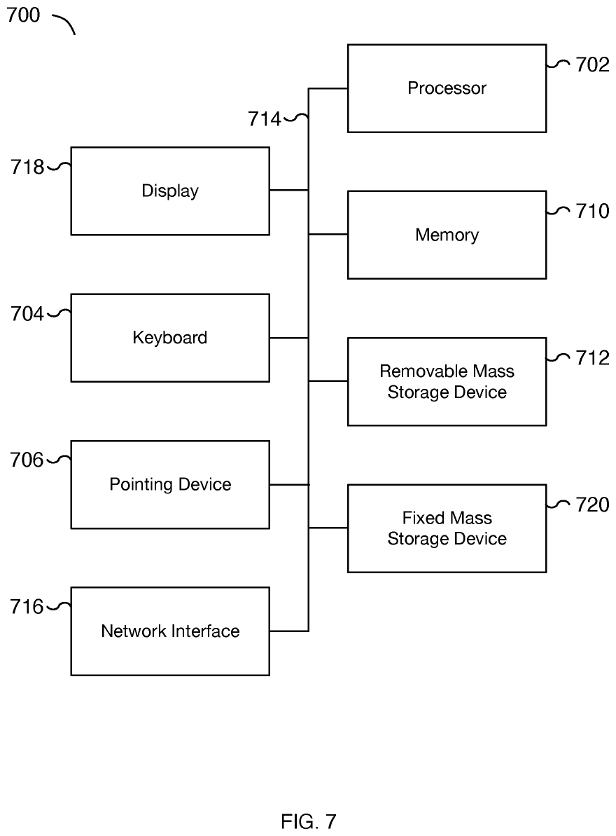

FIG. 7 is a functional diagram illustrating a programmed computer system for automatically enhancing and providing analytics for computer program development. As will be apparent, other computer system architectures and configurations can be utilized for automatically providing enhancements and analytics for a project management service. Examples of computer system 700 include one or more computers of clients 101 of FIG. 1, one or more computers of computer program development project management service 111 of FIG. 1, and/or one or more computers associated with project enhancements and analytics module 200 of FIG. 1. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In various embodiments, one or more instances of computer system 700 can be used to implement at least portions of the processes of FIGS. 3-6.

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or unidirectional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or unidirectionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a transcript of at least a portion of a discussion associated with a computer program development;
automatically analyzing at least a portion of the transcript to automatically identify a computer program development project associated with the discussion and managed by a computer program development project management software;
providing to a large language model, at least the portion of the transcript and contextual information of the computer program development project tracked using the computer program development project management software to automatically generate a specification of a task of the computer program development discussed during the discussion; and
based on the generated specification of the task, automatically tracking the task using the computer program development project management software.

2. The method of claim 1, wherein the task is associated with a new feature to be added or an identified defect of the computer program development project tracked using the computer program development project management software.

3. The method of claim 1, wherein the transcript includes one or more trigger words used to identify the task.

4. The method of claim 3, wherein the one or more trigger words associated with a new feature of the computer program development project include one or more of the following: “enhancement,” “suggestion,” “idea,” “improvement,” “request,” “innovation,” “fine-tuning,” or “optimization.”

5. The method of claim 3, wherein the one or more trigger words associated with an identified defect of the computer program development project include one or more of the following: “defect,” “problem,” “malfunction,” “missing,” “issue,” “inconsistency,” “blemish,” “imperfection,” or “bug.”

6. The method of claim 1, wherein providing to the large language model, at least the portion of the transcript and the contextual information of the computer program development project tracked using the computer program development project management software to automatically generate the specification of the task of the computer program development discussed during the discussion includes generating a generative artificial intelligence prompt using at least the portion of the transcript and at least a portion of the contextual information of the computer program development project.

7. The method of claim 6, wherein the generative artificial intelligence prompt further includes requirements associated with the specification of the task.

8. The method of claim 7, wherein the requirements associated with the specification of the task include a title, a description, an acceptance criteria, and an assignment group.

9. The method of claim 1, wherein the generated specification of the task is associated with a resource prediction for the task.

10. The method of claim 9, wherein the resource prediction is associated with an estimate of an amount of effort required to complete the task.

11. The method of claim 10, wherein the resource prediction is based at least in part on a number of developers and an associated skill level for each of the number of developers utilized to complete the task.

12. A system comprising:
one or more processors; and
a memory coupled to the one or more processors, wherein the memory is configured to provide the one or more processors with instructions which when executed cause the one or more processors to:
receive a transcript of at least a portion of a discussion associated with a computer program development;
automatically analyze at least a portion of the transcript to automatically identify a computer program development project associated with the discussion and managed by a computer program development project management software;
provide to a large language model, at least the portion of the transcript and contextual information of the computer program development project tracked using the computer program development project management software to automatically generate a specification of a task of the computer program development discussed during the discussion; and
based on the generated specification of the task, automatically track the task using the computer program development project management software.

13. The system of claim 12, wherein the task is associated with a new feature to be added or an identified defect of the computer program development project tracked using the computer program development project management software.

14. The system of claim 12, wherein the transcript includes one or more trigger words used to identify the task.

15. The system of claim 14, wherein the one or more trigger words associated with a new feature of the computer program development project include one or more of the following: “enhancement,” “suggestion,” “idea,” “improvement,” “request,” “innovation,” “fine-tuning,” or “optimization.”

16. The system of claim 14, wherein the one or more trigger words associated with an identified defect of the computer program development project include one or more of the following: “defect,” “problem,” “malfunction,” “missing,” “issue,” “inconsistency,” “blemish,” “imperfection,” or “bug.”

17. The system of claim 12, wherein providing to the large language model, at least the portion of the transcript and the contextual information of the computer program development project tracked using the computer program development project management software to automatically generate the specification of the task of the computer program development discussed during the discussion includes generating a generative artificial intelligence prompt using at least the portion of the transcript and at least a portion of the contextual information of the computer program development project.

18. The system of claim 17, wherein the generative artificial intelligence prompt further includes requirements associated with the specification of the task.

19. The system of claim 12, wherein the generated specification of the task is associated with a resource prediction for the task, and wherein the resource prediction is associated with an estimate of an amount of effort required to complete the task.

20. A computer program product, the computer program product being embodied in a non-transitory computer readable storage medium and comprising computer instructions for:
receiving a transcript of at least a portion of a discussion associated with a computer program development;
automatically analyzing at least a portion of the transcript to automatically identify a computer program development project associated with the discussion and managed by a computer program development project management software;
providing to a large language model, at least the portion of the transcript and contextual information of the computer program development project tracked using the computer program development project management software to automatically generate a specification of a task of the computer program development discussed during the discussion; and
based on the generated specification of the task, automatically tracking the task using the computer program development project management software.
